(19) United States
(12) Patent Application Publication
(10) Pub. No.: US 2003/0101198 A1
(43) Pub. Date: May 29, 2003

(54) Method and system for generating a configuration database file based on data files of ECAD tools

(76) Inventors: S. Brandon Keller, Evans, CO (US); Gregory Dennis Rogers, Fort Collins, CO (US); Charles Anthony Lelm, Windsor, CO (US)

Correspondence Address: HEWLETT-PACKARD COMPANY, Intellectual Property Administration, P.O. Box 272400, Fort Collins, CO, 80527-2400, US

(21) Appl. No.: 09/994,150

(22) Filed: Nov. 26, 2001

(51) Int. Cl. G06F 12/00

(52) U.S. Cl. 707/200

(57) ABSTRACT

A method for generating a configuration database file based on at least one data file of at least one ECAD tool included in a predefined tool list, which includes the steps of selecting an ECAD tool from the predefined tool list, reading a data file of the selected ECAD tool and generating a configuration database file based on the read data file.

The present invention generally relates to the configuration of computer aided design systems. More specifically, it relates to an improved method and system for generating a configuration database file based on at least one data file of at least one ECAD tool included in a predefined tool list.

Computer aided design (“CAD”) systems that design electronic circuits, often referred to as Electronic CAD (“ECAD”) tools, assist in the design of electronic circuits by providing a user with a set of software tools running on a digital computer with a graphical display device. The design process has now become so complex that the current generation of integrated circuit (IC) chips, particularly in the case of VLSI chips, often cannot be designed without the help of ECAD tools. ECAD tools are ideally suited to performing tasks implemented in the circuit design process because they can break down large, complicated circuits into a plurality of circuits of relatively simpler functionality. The ECAD tools can then iteratively lay out these much simpler circuits and achieve the desired overall design of the desired large complicated circuit.

In performing a circuit design task, the ECAD tool generally allows for a user to schematically create and/or edit circuit designs by graphically placing and connecting circuit components, which can be represented as objects by the ECAD tool. The ECAD tool performs calculational circuit design and evaluation tasks for the schematic circuit, such as optimizing the circuit, testing the circuit through simulation modeling, and the like. As represented by the ECAD tool, the circuit may comprise a plurality of “nets,” with each net representing a connection between the terminals of two or more transistors. A net may also be referred to as a signal. An ECAD tool also typically generates a “netlist,” which is a list of a group of logically related nets, including connectivity data for each. The netlist may be in the form of a database. Also, the netlist may describe a multiplicity of nets that can number into the millions for VLSI chips. As a result, netlists can be of enormous size and complexity.

Different types of sub-tools of an ECAD tool may also be used in IC design/evaluation tasks. Whenever an ECAD tool is used to analyze a netlist, it generally creates one or more output files from its processed analysis. In addition, there is often one or more configuration files, created by other ECAD tools or the users, that is associated with the ECAD tool. Both the output files and the configuration files include valuable information about the netlist and the ECAD tool, and the information helps other ECAD tools or engineers in further analysis.

With the current methods, ECAD tools sometimes attempt to read the configuration files and the output files of other ECAD tools. In this case, ECAD tools generally gather needed information directly from the output files of other ECAD tools or manually created configuration files from users. One problem is that when the ECAD tool automatically reads the output files or configuration files generated by other ECAD tools, it may be difficult for users to determine what information was used in the analysis by a particular ECAD tool. However, such information may be helpful to the engineers and may be needed at a later time. Furthermore, during an analysis by an ECAD tool, a previous configuration file may be changed by a user without other users' knowledge. As a result, unnecessary confusion is created, and users may be unable to change the configuration in an appropriate manner. Also, current practices often create unintended changes of the configuration files of the ECAD tools, because a change in the configuration file of one ECAD tool often affects the configuration of other ECAD tools. Thus, there is a need for an improved method for keeping track of the configuration files and the output files of the ECAD tools.

### BRIEF SUMMARY OF THE INVENTION

The present invention is directed to an improved method and system for generating a configuration database file based on data files of ECAD tools. More specifically, it relates to an improved method and system for generating a configuration database file based on one or more data files of one or more ECAD tools included in a predefined tool list.

The present invention provides a method that includes the steps of selecting an ECAD tool from a predefined tool list, reading a data file of the selected ECAD tool, and generating a configuration database file based on the read data file.

The present invention also provides a computer system that includes a storage medium and a processor for generating a configuration database file based on one or more data files of any ECAD tool included in a predefined tool list. The program further includes a set of instructions for selecting an ECAD tool from a predefined tool list, reading a data file of the selected ECAD tool, and generating a configuration database file based on the read data file.

### DESCRIPTION OF THE DRAWINGS

FIG. 1 shows a block diagram of a computer system on which the method may be performed; and,

FIG. 2 is a flow chart illustrating the preferred functionality of a method of the present invention.

### DETAILED DESCRIPTION

Broadly stated, the present invention is directed to an improved method and system for generating a configuration database file based on one or more data files of any ECAD tool included in a predefined tool list. An ECAD tool is first selected from a predefined tool list, followed by a data file of the selected ECAD tool to be read. A configuration database file based on the read data file is then generated.

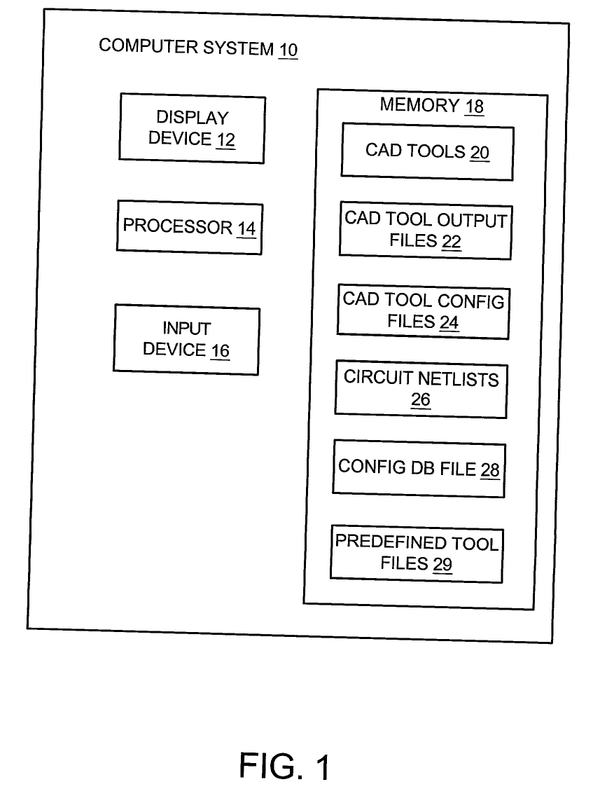

A block diagram of a computer system on which the present invention may be implemented is shown in FIG. 1, and indicated generally at 10. As with most typical computer systems, there is a display device 12 for displaying data to users, a processor 14 for processing data, an input device 16 for users to input data, and memory 18 for storing the data. The processor 14 accesses the memory 18, which may store, among other things, CAD tools 20, CAD tool output files 22 (output files are generally generated by the CAD tools as a result of their analysis), CAD tool configuration files 24 (configuration files contains configuration information about a particular ECAD tool, and they can be generated manually by the engineers or automatically by the CAD tools during their processes), a circuit netlist 26 (herein “netlist”) and a configuration database file generated by the present invention.

Since the present invention is preferably implemented as an CAD tool itself (herein “Invention CAD tool”), the Invention CAD tool, as well as various CAD tools 20 are stored in the memory 18 for analyzing the netlist 26, which is a data file for storing the topology of the chip design. The interconnection of the blocks is not shown as they are known to those skilled in the art. When in use, the input device 12 receives a command for instructing the processor 14 to call the Invention CAD tool software 20 that generates a configuration database file 28 according to a predefined tool list 29 defined with one or more of the other CAD tools. Prior to an analysis by one of the CAD tools in the predefined tool list, a configuration file 24 may be generated or changed by a user. After a result is obtained from the CAD tool's analysis, an output file 22 will typically be created by the CAD tool. From these output files 22 and input configuration files 24, the configuration database file 28 is generated for the CAD tools in the predefined tool list, and preferably there is a separate field for each file in the configuration database file. The configuration database file may then be displayed on the display device 12 to the users or be used by other CAD tools.

As a result of the many possible implementations for the present invention, an explanation of the current preferred embodiment of the computer system is given as an example. The complexity of the various available implementations is furthered not only by the use of different file formats that can change, but also because of the software or firmware that is needed to work with the given desired file formats. In trying to present a clearer description of the present invention, an ECAD tool implementation will be used as an example. However, it should be understood that others skilled in the art can appreciate the implementations of the various systems and configurations, and these implementations are within the scope of the present invention.

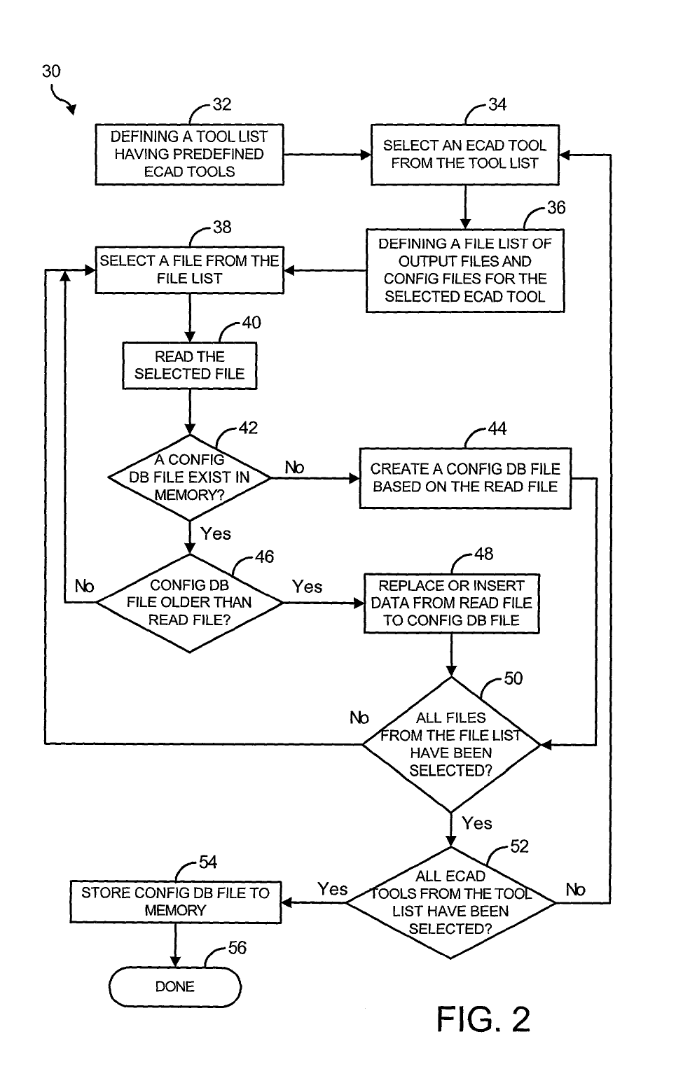

Turning to an important aspect of the present invention, a flow chart of the preferred functionality of a method of the present invention is shown in FIG. 2, and indicated generally at 30. The method is preferably initiated automatically by ECAD tools upon a certain predefined command. However, manual initiation by users is also contemplated, depending on the design and needs of the implementation. Thus, it should be understood that other various methods of initiation are within the scope of the present invention.

A predefined tool list including one or more ECAD tools is first defined preferably by users (block 32). Because the users can customize the tool list of ECAD tools according to their needs and desires, a user can use multiple tool lists that generate multiple configuration database files. By generating multiple configuration database files according to predefined tool lists, the present invention enable users to keep track of data files that are more customized. Consequently, while an ECAD tool may change a configuration file for one of its analyses, the present invention enables the user to either use the prior configuration of the ECAD tool, or automatically update the configuration database file without affecting the configuration files of any other ECAD tools.

Nevertheless, the tool list can be defined automatically by other ECAD tools or other programs. Furthermore, any number of ECAD tools can be included. Users can define all the ECAD tools stored in memory, or a predetermined number of predefined ECAD tools can also be included. Again, this depends on the desired implementation of the user. Accordingly, these other various ways of defining the tool list are contemplated and within the scope of the present invention.

After a tool list is defined (block 32), an ECAD tool is then selected from the predefined tool list for processing (block 34). A file list including the data files for the selected ECAD tool is also preferably defined (block 36). The data files preferably include all the output files and configuration files of the selected ECAD tool. However, any type or number of data files can be included and are contemplated. For example, the user may want to keep track of other types of data files relating to the ECAD tool or data files according to a predefined date. User customizations of both the tool list and the file list are contemplated by the present invention, and other various methods to implement these customizations are within the scope of the present invention. In addition, the file list is preferably defined automatically by the algorithm of the present invention. However, the file list can also be defined by users, other ECAD tools or other related programs. Accordingly, other alternative methods according to the implementation chosen by the user are contemplated, and they are within the scope of the present invention.

After the file list has been defined (block 36), a data file is selected (block 38) and read (block 40) from the file list. Then, a step of determining whether a configuration database file exists in the memory is preformed (block 42). In other words, it is determined whether a previously saved configuration database file has already been saved on the system. If not, a new configuration database file based on the data read from the data file is created (block 44). It should be noted that, although the next step is preferably performed shortly after any steps where a determination is required (i.e., a decision box), the present invention, nevertheless, contemplates other steps being inserted between the determining step and any steps following immediately after. Because there are numerous ways to implement the method of the present invention, the present method contemplates alternating the orders of the steps and adding other additional steps. These alternative methods should be understood to be within the scope of the present invention.

If, on the other hand, there is a configuration database file that is already in the memory (block 42), it is then determined whether this configuration database file is older than the read data file (block 46). If the configuration database file is not older than the read data file (block 46), it indicates that the read data file has already been added to this configuration database file at some previous time. As a result, it is unnecessary to process the read data file, and the process can reloop back to select another data file from the file list (block 38). Conversely, if the configuration database file is not older than the read data file (block 46), which indicates that the read file has not been processed, the data from the read data file is then replaced or inserted into the previously saved configuration database file (block 48).

Once the data from the read data file has been added to either a new configuration database file (block 44) or an existing configuration database file (block 48), it is determined whether all data files from the file list have been selected (block 50). In other words, it is checked to determine whether all the data files included in the file list have been processed. If not, the process reloops back to select another data file from the list (block 38). Otherwise, the process continues, but this time, it is determined whether all ECAD tools from the predefined tool list have been selected (block 52). Similarly, if all ECAD tools from the predefined tool list have not been selected for processing, the method reloops back to select another ECAD tool from the tool list (block 34). Once it is determined that all ECAD tools from the tool list have been selected (block 52), the configuration database file is then stored to the memory (block 54), which can later be used by other ECAD tools or users. The process is then completed (block 56).

From the foregoing description, it should be understood that an improved system and method for generating a configuration database file have been shown and described, which have many desirable attributes and advantages. The system and method provide a way for users to generate the configuration of an ECAD tool without affecting other configuration information. Furthermore, users are provided direct visibility into the actual configuration of the ECAD tools. With the generation of the configuration database file, the configuration files of two different ECAD tools remain independent of each other. As a result, it is also now possible to change the configuration of one ECAD tool without affecting the configuration of other ECAD tools. Consequently, a more flexible and efficient method is provided while users are given more control and visibility of the ECAD tools' configurations.

As shown, users can now customize what is to be logged in the configuration database file by predefining the ECAD tools to be included in the tool list. As a result, a user can generate multiple configuration database files, according to the needs and desires of the user. By generating multiple configuration database files according to predefined tool lists, the present invention enables users to keep track of data files that are more customized. Consequently, while a user of a ECAD tool may change a configuration file prior to an analysis, the present invention can either use the configuration information stored prior to the change, or update the configuration database file without affecting the configuration files of other ECAD tools.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for generating a configuration database file based on at least one data file of at least one ECAD tool included in a predefined tool list, said method comprising the steps of:
selecting an ECAD tool from the predefined tool list;
reading a data file of said selected ECAD tool; and,
generating a configuration database file based on said read data file.

2. The method according to claim 1 further comprising the steps of:
determining whether all ECAD tools from the tool list have been selected;
selecting a next ECAD tool when all ECAD tools have not been selected from the tool list; and,
storing said configuration database file when all ECAD tools have been selected from the tool list.

3. The method according to claim 1 wherein prior to said step of selecting an ECAD tool further comprises the step of defining a tool list having predefined ECAD tools.

4. The method according to claim 1 wherein said step of selecting an ECAD tool further comprises the steps of:
defining a file list including at least one predefined data file of said selected ECAD tool; and,
selecting a data file from said file list.

5. The method according to claim 4 wherein said at least one predefined data file includes an output file generated by said selected ECAD tool.

6. The method according to claim 4 wherein said at least one predefined data file includes a configuration file associated with said selected ECAD tool.

7. The method according to claim 4 wherein said step of selecting a data file further comprises the steps of:
determining whether all data files from the file list have been selected; and,
selecting a next data file from the file list until all said at least one predefined data file have been selected.

8. The method according to claim 1 wherein said step of reading a file further comprises the steps of:
determining whether all data files of said selected ECAD tool have been read; and,
reading a next data file of said selected ECAD tool until all data files of said selected ECAD tool have been read.

9. The method according to claim 1 wherein said step of generating a configuration database file further comprises the steps of:
determining whether a configuration database file exists in memory;
creating a new configuration database file based on the read data file when a configuration database file does not exist in memory;
determining whether a configuration database file is older than the read data file when a configuration database file does exist in memory; and,
appending data from the read data file to the existing configuration database file.

10. A computer system for generating a configuration database file based on at least one data file of at least one ECAD tool included in a predefined tool list, comprising:
a storage medium;
a processor for executing a program stored on the storage medium for generating a configuration database file based on at least one data file of at least one ECAD tool included in a predefined tool list, the program comprising a set of instructions for:
selecting an ECAD tool from the predefined tool list;
reading a data file of said selected ECAD tool; and,
generating a configuration database file based on said read data file.

11. A computer program product comprising a computer usable medium having computer readable program codes embodied in the medium that when executed causes a computer to:
select an ECAD tool from a predefined tool list including at least one ECAD tool;
reading a data file of said selected ECAD tool; and,
generating a configuration database file based on said read data file.
